(19) United States
(12) Patent Application Publication
(10) Pub. No.: US 2019/0370767 A1
(43) Pub. Date: Dec. 5, 2019

(54) Systems and Methods to Predict Potential Entities to Switch Mode of Payment

(71) Applicant: Visa International Service Association, San Francisco, CA (US)

(72) Inventors: Bharadwaj Jayaraman, Bangalore (IN); Venkata Sai Praneeth Kumar Sahini, Bangalore (IN); Inshuya Muthukumar, Bangalore (IN); Shaz Ahamed, Bangalore (IN); Venkata Reddy Mylarapu, Bangalore (IN)

(21) Appl. No.: 16/427,474

(22) Filed: May 31, 2019

(30) Foreign Application Priority Data
Jun. 1, 2018 (IN) 201841020591

(51) Int. Cl. G06Q 20/12; G06Q 20/34; G06Q 20/32; G06N 5/04

(52) U.S. Cl. CPC G06Q 20/12; G06N 5/046; G06Q 20/322; G06Q 20/34

(57) ABSTRACT

Embodiments of present disclosure relate to systems and methods for predicting potential entities to switch from first to second payment mode. Each entity of a plurality of entities is profiled using transaction pattern of corresponding entities. Clusters for the entities is generated based on profiling. Each cluster includes entities with similar transaction pattern. Adapted entities that are adapted to use the second payment mode is identified. Adapted entities are identified based on tracking spend behavior of each entity. Further, clusters including the adapted entities are identified to be target clusters. Upon identifying the target clusters, predicted entities in the target clusters are determined as potential entities to switch from first payment mode to second payment mode. The predicted entities do not include any entities from the adapted entities. Real-time customized notification is provided to predicted entities, to promote to switch from first payment mode to second payment mode.

### CROSS REFERENCE TO RELATED APPLICATION

This application claims priority to Indian Provisional Application No. 201841020591, filed Jun. 1, 2018, the entire disclosure of which is hereby incorporated by reference in its entirety.

### TECHNICAL FIELD

The present disclosure relates generally to tracking of transaction details of plurality of entities and more specifically to predict potential entities to switch from first payment mode to second payment mode based on the tracking.

### BACKGROUND

In today's world of emerging technologies, industry pertaining to payment processing, and mobile payments are greatly in-demand by consumers. Mobile payments technology allows consumers to use a mobile device for making payment for purchase of goods or services, instead of using cash, cheque or credit card. However, the lack of awareness of consumers on mobile payments, have hindered the widespread adoption of such technology. Most of the consumers are still using the debit card or credit card-based point of sale systems. With rapid development of online trading and payment processing through the mobile network, there is a huge possibility or interest of the cardholder to switch to mobile payments. Methods of promoting or encouraging cardholders for adoption of mobile payments include advertising such as displaying ads, providing offers for opting mobile payments, tie-ups with popular merchants and other related traditional practices. These methods may not be efficient as offers may be provided to cardholders who are not interested in switching to mobile payments. Accordingly, identification of cardholders who are likely to adopt mobile payment methods, is required to increase the users of mobile payments methodologies and provide offers to such users.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a computer-implemented method for predicting potential entities to switch from first payment mode to second payment mode. The method is performed using one or more processors. Initially, each entity of a plurality of entities is profiled using a transaction pattern of corresponding entities. The plurality of entities uses the first payment mode. A plurality of clusters for the plurality of entities is generated based on the profiling. Each cluster of the plurality of clusters comprises one or more entities with a similar transaction pattern. A plurality of adapted entities from the plurality of entities that are adapted to use the second payment mode is identified. The plurality of adapted entities is identified based on tracking a spend behavior of each entity of the plurality of entities. Further, one or more clusters from the plurality of clusters, comprising the plurality of adapted entities, are identified to be target clusters. Upon identifying the target clusters, plurality of predicted entities in the target clusters are determined as one or more potential entities to switch from the first payment mode to the second payment mode. The predicted entities do not include any entities from the plurality of adapted entities. Real-time customized notification is provided to the predicted entities, to promote to switch from the first payment mode to the second payment mode.

In an embodiment, the present disclosure relates to system for predicting potential entities to switch from first payment mode to second payment mode. The system includes a one or more processors and a memory communicatively coupled to the one or more processors. The memory stores processor-executable instructions, which on execution cause the one or more processors to predict the potential entities. Initially, each entity of a plurality of entities is profiled using a transaction pattern of corresponding entities. The plurality of entities uses the first payment mode. A plurality of clusters for the plurality of entities is generated based on the profiling. Each cluster of the plurality of clusters comprises one or more entities with a similar transaction pattern. A plurality of adapted entities from the plurality of entities that are adapted to use the second payment mode is identified. The plurality of adapted entities is identified based on tracking a spend behavior of each entity of the plurality of entities. Further, one or more clusters from the plurality of clusters, comprising the plurality of adapted entities, are identified to be target clusters. Upon identifying the target clusters, plurality of predicted entities in the target clusters are determined as one or more potential entities to switch from the first payment mode to the second payment mode. The predicted entities do not include any entities from the plurality of adapted entities. Real-time customized notification is provided to the predicted entities, to promote to switch from the first payment mode to the second payment mode.

In an embodiment, the present disclosure relates to non-transitory computer readable medium including instructions stored. The instruction when processed by at least one processor cause a device to perform prediction of potential entities to switch from first payment mode to second payment mode. Initially, each entity of a plurality of entities is profiled using a transaction pattern of corresponding entities. The plurality of entities uses the first payment mode. A plurality of clusters for the plurality of entities is generated based on the profiling. Each cluster of the plurality of clusters comprises one or more entities with a similar transaction pattern. A plurality of adapted entities from the plurality of entities that are adapted to use the second payment mode is identified. The plurality of adapted entities is identified based on tracking a spend behavior of each entity of the plurality of entities. Further, one or more clusters from the plurality of clusters, comprising the plurality of adapted entities, are identified to be target clusters. Upon identifying the target clusters, plurality of predicted entities in the target clusters are determined as one or more potential entities to switch from the first payment mode to the second payment mode. The predicted entities do not include any entities from the plurality of adapted entities. Real-time customized notification is provided to the predicted entities, to promote to switch from the first payment mode to the second payment mode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows exemplary environment of a system for predicting potential entities to switch from first payment mode to second payment mode, in accordance with some embodiments of the present disclosure;

FIG. 2 shows a detailed block diagram of a system for predicting potential entities to switch from first payment mode to second payment mode, in accordance with some embodiments of the present disclosure;

FIGS. 3a and 3b illustrate exemplary representations of plurality of clusters, in accordance with some embodiments of present disclosure;

FIG. 4a illustrates a flowchart showing an exemplary method to predict potential entities to switch from first payment mode to second payment mode, in accordance with some embodiments of present disclosure;

FIG. 4b illustrates a flowchart showing an exemplary method to identify adapted entities in plurality of entities, in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure relates to a method and system for accurately predicting potential entities to switch from one payment mode to another payment mode. The potential entities are targeted with notifications for promoting to switch from one payment mode to another payment mode. For the prediction, transaction patterns of entities may be tracked and cluster of entities with similar transaction pattern is generated. Further, spend behavior of the entities is used to identify target cluster with adapted entities which are adapted to use the second payment mode. Entities apart from the adapted entities in target clusters are identified as the potential entities. Further, the identified potential entities are notified to promote switching from the first payment mode to the second payment mode. The present disclosure eliminates need for notifying entities who may not potentially switch from the first payment mode to the second payment mode.

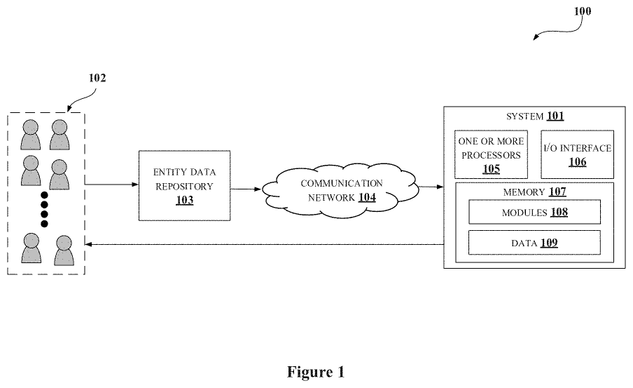

FIG. 1 shows exemplary environment of a system for predicting potential entities to switch from first payment mode to second payment mode, in accordance with some embodiments of the present disclosure. The environment 100 may include the system 101 in communication with plurality of entities 102, an entity data repository 103 and a communication network 104. The plurality of entities 102 may be users who may be adapted to make payment via the first payment mode. In an embodiment, the first payment mode may be payment via card transaction.

Each of the plurality of entities 102 may be a cardholder with predefined identification data. In one embodiment, a card associated with the plurality of entities 102 may be a debit card or credit card. The entity data repository 103 may be configured to store transaction patterns and spend behaviors associated with each of the plurality of entities 102. In an embodiment, the transaction pattern of an entity includes merchant data and transaction data associated with transactions of the entity. In an embodiment, the spend behavior may indicate number of transactions performed by each of the plurality of entities 102 using a payment mode. For example, the spend behavior of an entity may indicate number of transactions performed by the entity via the first payment mode and the number of transactions performed by the entity by the second payment mode.

In an embodiment, the transaction pattern and the spend behavior of each entity may be tracked via dedicated units. For example, in real time, when an entity makes a payment via card transaction, details of transaction comprising, type of transaction, amount of money spent, location where the transaction happened, and other transaction related data may be recorded. The recorded details may be stored as the transaction data in the entity data repository 103. Further, the merchant data may be acquired for a transaction performed by the entity. The merchant data may include merchant category, trade location and other details related to a merchant associated with the transaction. The merchant data may be received and stored in the entity data repository 103. In an embodiment, a single server (not shown in the figure) may be configured to track transactions of an entity from the plurality of entities and determine the transaction pattern and the spend behavior of the entity. The server may communicate the transaction pattern and the spend behavior to the entity data repository 103. In an embodiment, such server may be a dedicated server or a cloud-based server. In an embodiment, the entity data repository 103 may be integral part of the server. In another embodiment, the server along with the entity data repository 103 may be integral part of the system 101.

In an embodiment, the system 101 may be configured to communicate with the entity data repository 103 to retrieve the transaction pattern and the spend behavior of each of the plurality of entities 102. The system 101 may communicate with the entity data repository 103 via the communication network 104. The communication network 104 may include, without limitation, a direct interconnection, Local Area Network (LAN), Wide Area Network (WAN), wireless network (e.g., using Wireless Application Protocol), the Internet, and the like. As shown in the figure, the system 101 may include one or more processors 105, Input/Output (I/O) interface 106, and a memory 107. In some embodiments, the memory 107 may be communicatively coupled to the one or more processors 105. The memory 107 stores instructions, executable by the one or more processors 105, which, on execution, may cause the system 101 to predict the plurality of potential entities, as disclosed in the present disclosure. In an embodiment, the memory 107 may include one or more modules 108 and data 109. The one or more modules 108 may be configured to perform the steps of the present disclosure using the data 109, to predict the potential entities. In an embodiment, each of the one or more modules 108 may be a hardware unit which may be outside the memory 107 and coupled with the system 101.In an embodiment, the system 101, for predicting the plurality of potential entities, may be implemented in a variety of computing systems, such as a laptop computer, a desktop computer, a Personal Computer (PC), a notebook, a smartphone, a tablet, e-book readers, a server, a network server, a cloud-based server and the like. In an embodiment, the system 101 may include an intelligent predictive model to predict the potential entities. In an embodiment, such predictive model may be machine learning model or deep learning model, which may be built using neural networks. In an embodiment, the system 101 may be configured to receive and transmit data via the I/O interface 106. Received data may include the transaction patterns and the spend behavior from the entity data repository 103. Transmitted data may include real-time customized notification provided to the plurality of potential entities.

For predicting the potential entities, the system 101 may be configured to perform profiling of each of the plurality of entities 102. The profiling may be performed using the transaction pattern of corresponding entities. One or more techniques, known to a person skilled in the art, may be implemented to perform the profiling of the plurality of entities 102.

Upon profiling each of the plurality of entities, plurality of clusters is generated for the plurality of entities. The plurality of clusters may be generated based on the profiling. Each cluster from the plurality of clusters comprises one or more entities with a similar transaction pattern. In an embodiment, the plurality of clusters may be generated using K-means clustering technique. In an embodiment, inter-cluster distances and intra-cluster similarities for the plurality of clusters may be determined to increase efficiency of the plurality of clusters. The inter-cluster distances and intra-cluster similarities may be determined based on the transaction pattern associated with the one or more entities in corresponding clusters.

Further, a plurality of adapted entities from the plurality of entities are identified. The plurality of adapted entities may be adapted to use the second payment mode. The second payment mode is different from that of the first payment mode. In an embodiment, the second payment mode may be payment via a user device. In an embodiment, the user device may be a mobile phone, a smart apparatus, Personal Digital Assistant (PDA), and so on. In an embodiment, payment via the second payment mode may be done using a mobile application in the user device.

The plurality of adapted entities may be identified based on tracking the spend behavior of each entity from the plurality of entities. In an embodiment, for identifying the plurality of adapted entities from the plurality of entities, the system 101 may be configured to track number of transactions performed by the plurality of entities via the second payment mode, for a predefined duration of time. Upon tracking, an entity may be identified to be adapted to the second payment mode when the number of transactions is greater than a predefined threshold value. In an embodiment, the predefined threshold value may be half of total number of transactions performed by the entity.

Further, one or more clusters from the plurality of clusters, comprising the plurality of adapted entities, are identified to be target clusters. Plurality of predicted entities, apart from the plurality of adapted entities in the target clusters, are determined as potential entities to switch from the first payment mode to the second payment mode.

Real-time customized notification may be provided to the plurality of predicted entities. The real-time customized notification may be provided to promote each of the plurality of predicted entities to switch from the first payment mode to the second payment mode. In an embodiment, the real-time customized notification may be, but not limited to, advertisement, offers, discounts, coupons and so on.

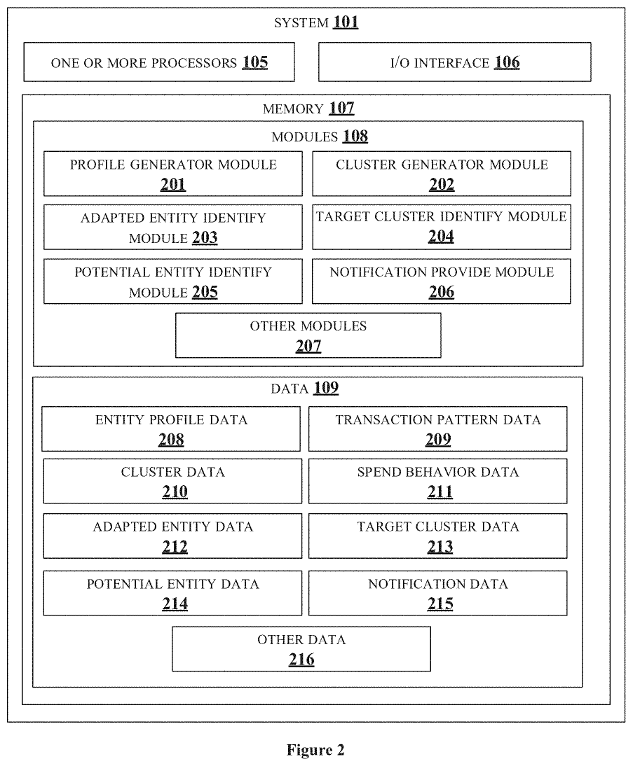

FIG. 2 shows a detailed block diagram of the system 101 for predicting the potential entities to switch from the first payment mode to the second payment mode, in accordance with some embodiments of the present disclosure.

The data 109 and the one or more modules 108 in the memory 107 of the system 101 is described herein in detail.

In one implementation, the one or more modules 108 may include, but are not limited to, a profile generator module 201, a cluster generator module 202, an adapted entity identify module 203, a target cluster identify module 204, a potential entity identify module 205, notification provide module, and one or more other modules 207, associated with the system 101.

In an embodiment, the data 109 in the memory 107 may include entity profile data 208, transaction pattern data 209 (also referred to as transaction pattern 209), cluster data 210 (also referred to as plurality of clusters 210), spend behavior data 211 (also referred to as spend behavior 211), adapted entity data 212 (also referred to as plurality of adapted entities 212), target cluster data 213 (also referred to as target clusters 213), potential entity data 214 (also referred to as plurality of potential entities 214), notification data 215 (also referred to as real-time customized notification 215 or notification 215 or customized notification 215) and other data 216 associated with the system 101.

In an embodiment, the data 109 in the memory 107 may be processed by the one or more modules 108 of the system 101. In an embodiment, the one or more modules 108 may be implemented as dedicated units and when implemented in such a manner, said modules may be configured with the functionality defined in the present disclosure to result in a novel hardware. As used herein, the term module may refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality.

The one or more modules 108 of the present disclosure function to predict the potential entities to switch from the first payment mode to second payment mode. The one or more modules 108 along with the data 109, may be implemented in any system, for predicting the potential entities.

For predicting the potential entities, initially, the profile generator module 201 may be configured to perform profiling of each of the plurality of entities 102. By profiling, a profile for each of the plurality of entities 102 may be generated. The profile may be stored as the entity profile data 208 in the memory 107. In one embodiment, the profile of an entity may provide intelligence information on behavior, pattern, preference, propensity, tendency, frequency, trend, and budget of the entity in making purchases. In one embodiment, the profile may include information about what the entity owns, such as points, miles, or other rewards currency, available credit, and received offers, such as coupons loaded into transaction accounts of the entity. In one embodiment, the profile may include information based on past offer/coupon redemption patterns. In one embodiment, the profile may include information on shopping patterns in retail stores as well as online stores associated with the entity. The shopping patterns may include frequency of shopping, amount spent in each shopping trip, distance of merchant location from address of the account holder and so on. One or more other information relating to an entity from the plurality of entities and the information which may be used in the present disclosure, may be stored as the entity profile data 208 for the entity.

The profiling may be performed using the transaction pattern 209 of corresponding entities. The transaction pattern 209 may be information associated with transactions associated with each of the plurality of entities. The information may be specific to at least one of transaction data and merchant data. In one embodiment, transaction data may include, but is not limited to, records of transactions made via credit accounts, debit accounts, prepaid accounts, bank accounts, stored value accounts and so on. In one embodiment, the merchant data may include, but is not limited to, location, business, products and/or services of merchant that receive payments from the entity for each of the transactions of the entity. In an embodiment, such transaction pattern 209 may be stored in the entity data repository 103 associated with the system 101. The profile generator module 201 may receive the transaction pattern 209 from the entity data repository 103 for profiling.

In an embodiment, the transaction data and the merchant data may be generated by a transaction handler associated with transaction terminal associated with the entity. The transaction terminal may be configured to initiate financial transactions for the entity. In one embodiment, the financial transactions may be performed via an account identification device, such as financial transaction cards including credit cards, debit cards, banking cards and so on. The financial transaction cards may be embodied in user devices, such as plastic cards, chips, Radio Frequency Identification (RFID) devices, mobile phones, Personal Digital Assistants (PDAs), which may enable performing financial transaction via the user device. The financial transactions may be made via directly using account information of the entity, without physically presenting the account identification device.

The transaction handler may be configured to process the financial transactions of the entity to generate the transaction data and the merchant data and determine transaction pattern 209 for the entity. The profile generator module 201 of the system may be configured to receive the transaction pattern 209 determined for the entity to perform profiling and generate a profile for the entity. The profile generator module 201 may be configured to retrieve such transaction patterns for each of the plurality of entities from corresponding transaction handler. Using respective transaction pattern, the profile generator module 201 may be configured to generate profile for corresponding entity. In an embodiment, the profile generator module 201 may be configured to receive the transaction data and the merchant data of the entity to determine the transaction pattern 209 of the entity and thereby, generate profile for the entity based on the transaction pattern. In an embodiment, the profile generator module 201 may be configured to update profiles of the plurality to entities 102. The profile generator module 201 may be configured to track transaction patterns of the plurality of entities 102 and update the profiles based on tracking. One or more techniques, known to a person skilled in the art, may be implemented for updating the profiles of the plurality of entities 102. In one embodiment, the profile generator module 201 may be configured to generate and update the profiles periodically. In other embodiments, the profile generator module 201 may be configured to generate the profiles in real-time, or just in time, in response to a request received when predicting the potential entities.

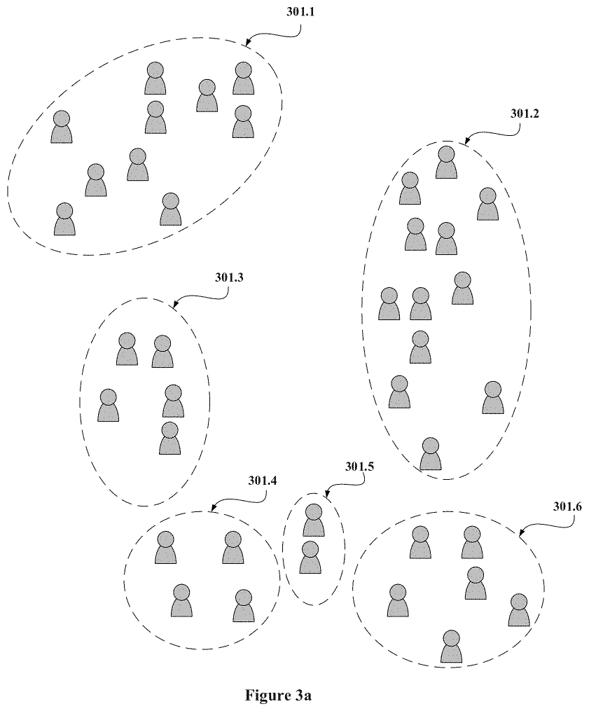

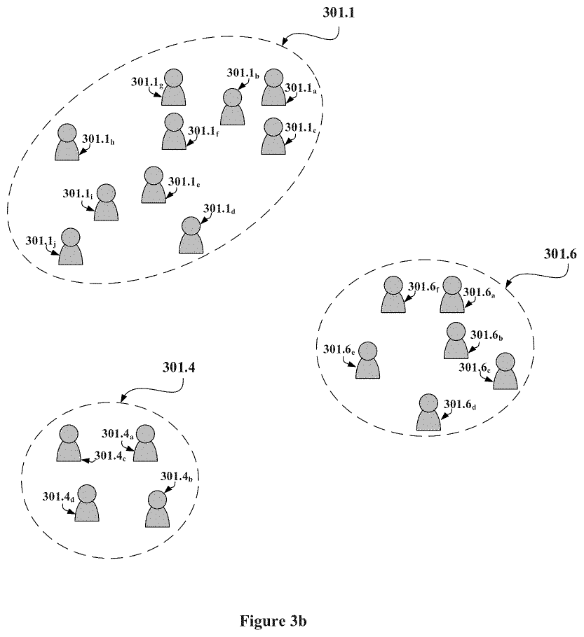

Upon profiling each of the plurality of entities 102, the cluster generator module 202 may be configured to generate plurality of clusters 210 for the plurality of entities 102. The plurality of clusters 210 may be generated based on the profiling. Each cluster from the plurality of clusters 210 comprises one or more entities with a similar transaction pattern. FIG. 3a illustrates an exemplary representation of plurality of clusters 210 generated for the plurality of entities 102. The cluster generator module 202 may generate plurality of clusters 301.1 . . . 301.5 (together referred to as plurality of clusters 301) for the plurality of entities 102, using transaction patterns of each of the plurality of entities 102. In an embodiment, the cluster generator module 202 may comprises a clustering model which is configured to generate the plurality of clusters 301. In an embodiment, K-means clustering technique may be employed to generate the plurality of clusters 301. In an embodiment, one or more clustering techniques, known to a person skilled in the art, may be implemented for grouping the plurality of entities 102 based on similarities in the transaction pattern. One or more features relating to the transactions of the plurality of entities 102 may be used for generating the plurality of clusters 301. For example, one or more entities that tend to shop at similar merchant groups may be placed into the same cluster. One or more entities that are in same geographical location may be placed into the same cluster. One or more entities that perform financial transaction for similar kind of products may be placed into the same cluster. One or more other feature relating to transactions of the plurality of entities may be used for performing the clustering. In an embodiment, accuracy of prediction of the potential entities may depend on the one or more features that are used for the clustering. Hence, it may be necessary to identify best features among available features relating to transactions of the plurality of entities. In an embodiment, each of the plurality of clusters 210 may be generated with a cluster ID. In an embodiment, the cluster data 210 in the memory 107 may include cluster ID for each of the plurality of clusters 210, along with information of entities associated with each of the plurality of clusters 210. In an embodiment, the cluster data 210 may include features associate with each of the plurality of clusters 210.

In an embodiment, the cluster generator module 202 may be configured to determine inter-cluster distances and intra-cluster similarities for the plurality of clusters 210. The inter-cluster distance may be determined for clusters amongst the plurality of clusters 210. In an embodiment, efficiency of clustering may be determined by computing the inter-cluster distances and the intra-cluster similarities in terms of merchant attributes and transaction volumes. In an embodiment, the cluster data 210 may include the inter-cluster distances and the intra-cluster similarities of each of the plurality of clusters 210.

In an embodiment, the inter-cluster distance may indicate a value indicating similarities between the two clusters. In an embodiment, distance between the two clusters and location of plurality of clusters 210 in clustering space may be determined based on the inter-cluster distance. Further, the intra-cluster similarities for an entity may be determined to understand relativeness of the entity with the feature associated with corresponding cluster. Placement of the entity in the cluster may depend on the intra-cluster similarities. For example, when value of the intra-cluster similarities is maximum for an entity in a cluster, distance of the entity from the centroid of the cluster is maximum as well. Similarly, when the value of the intra-cluster similarities is least for an entity in a cluster, the entity is placed nearest to the centroid of the cluster. One or more computation techniques, known to a person skilled in the art, may be implemented for computing the inter-cluster distance and the intra-cluster similarities.

Upon generating the plurality of clusters 210, the adapted entity identify module 203 may be configured to identify plurality of adapted entities 212 from the plurality of entities 102. The plurality of adapted entities 212 may be entities which are adapted to use the second payment mode. In an embodiment, the adapted entity data 212 in the memory 107 may include information of entities which are identified as the plurality of adapted entities 212. The plurality of adapted entities 212 may be identified based on tracking the spend behavior 211 of each entity of the plurality of entities 102. For example, payment mode used by an entity for the financial transaction is tracked as the spend behavior 211. In an embodiment, the spend behavior may indicate number of transactions performed by each of the plurality of entities 102 using a payment mode. For example, the spend behavior 211 of an entity may indicate number of transactions performed by the entity via the first payment mode and the number of transactions performed by the entity by the second payment mode. If the entity is identified to be using the second payment mode for more than or equal to 50% of total financial transactions of the entity, such entity may be identified to be the adapted entity. The spend behavior 211 may be retrieved from the transaction data of the entity. In an embodiment, the adapted entity identify module 203 may be configured to determine the spend behavior 211 of the entity to identify the entity to be an adapted entity. In an embodiment, the spend behavior 211 of the entity is monitored for a predefined duration of time. Payment modes used by the entity during the predefined duration of time is analyzed to identify the entity to be the adapted entity.

Further, the target cluster identify module 204 may be configured to identify one or more clusters from the plurality of clusters 210 comprising the plurality of adapted entities 212. Such one or more clusters are identified to be target clusters 213. In an embodiment, cluster with at least half number of adapted entities may be the target clusters 213. For example, consider clusters 301.1, 301.2, 301.4 and 301.6 to include the adapted entities. Number of the adapted entities in the cluster 301.1 is 5, number of the adapted entities in the cluster 301.2 is 3, number of the adapted entities in the cluster 301.4 is 3 and number of the adapted entities in the cluster 301.6 is 4. In this case, the target cluster identify module 204 may be configured to identify clusters 301.1, 301.4 and 301.6 as the target clusters 213. In an embodiment, the target clusters 213 may be clusters in which number of adapted entities is greater than number of entities which are not adapted to second payment mode. Other methods, known in the art, may be implemented to identify the target clusters 213 based on the adapted entities. In an embodiment, the target cluster data 213 may include the cluster ID of the identified target cluster along with information of entities associated with the target clusters 213.

In the target clusters 213, the potential entity identify module 205 may be configured to identify entities apart from the plurality of adapted entities 212 to be the plurality of predicted entities in the target clusters 213. Such plurality of predicted entities are potential entities 214 to switch from the first payment mode to the second payment mode. For example, consider the target clusters 301.1, 301.4 and 301.6 as shown in FIG. 3b. The entities in the clusters 301.1 are 301.1ₐ . . . 301.1ⱼ, the entities in the clusters 301.6 are 301.6ₐ . . . 301.6_{f} and the entities in the clusters 301.4 are 301.4ₐ . . . 301.4_{d}. Consider entities 301.1ₐ, 301.1_{c}, 301.1_{d}, 301.1ₕ, 301.1ᵢ and 301.1ⱼ are the plurality of adapted entities 212 in the cluster 301.1. Entities 301.1_{b}, 301.1ₑ, 301.1_{f} and 301.1_{g} which are remaining entities may be predicted to be the potential entities 214. Similarly, consider entities 301.4_{b}, 301.4_{c} and 301.4ₐ, are the plurality of adapted entities 212 in the cluster 301.4. Entity 301.4ₐ is predicted to be the potential entity 214. Similarly, consider entities 301.6ₐ, 301.6_{b}, 301.6_{c} and 301.4_{d} are the plurality of adapted entities 212 in the cluster 301.6. Entities 301.6ₑ and 301.6_{f} are predicted to be the potential entities 214. In an embodiment, the potential entity data 214 may include information associated with the predicted entities. The information may include location details, contact details, transaction pattern, spend behavior 211 and so on. The information may be used for promoting switching from the first payment mode to the second payment mode. In an embodiment, the predicted entities may also be referred to as target entities.

Upon identifying the potential entities 214, the notification provide module 206 may be configured to provide real-time customized notification 215 to the potential entities 214. The real-time customized notification 215 may be provided to promote each of the potential entities 214 to switch from the first payment mode to the second payment mode. In an embodiment, the notification provide module 206 may be configured to generate the notification 215 in real-time to provide to the potential entities. The notification data 215 may be provided to user devices of the potential entities 214. In an embodiment, the notification data 215 may be customized based on the transaction profile of corresponding potential entity. In an embodiment, information of the potential entities 214 may be stored and the notification 215 may be provided to a potential entity at a scheduled time. In an embodiment, the notification 215 may be provided to the potential entity based on location of the potential entity. For example, consider the potential entity enters a merchant franchise which is deployed with a proximity detection device. The proximity detection device may trigger the system 101 to provide a customized notification 215 with respect to the merchant. The customized notification 215 may offer a discount on a product that the potential user may most likely purchase with a condition that transaction for product needs to be performed via the second payment mode. This may trigger switching of payment mode used by the potential entity from the first payment mode to the second payment mode. Similarly, one or more other factors, may influence on generating and providing a customized notification 215. The one or more other factors may include, but is not limited to, browsing history of the potential entity, location of the potential entity, one or more previous purchases of the potential entity and so on. The notification 215 may be customized to be at least one of an advertisement, an offer, a discount, a promotion, a coupon and so on. The notification 215 may be of any form to promote switching from the first payment mode to the second payment mode. The notification 215 to be provided to the plurality of potential entities 214 may be stored as the notification data 215 in the memory 107.

Since transaction trends tend to change with time, the system 101 may be configured to predict the plurality of potential entities 214 periodically to identify new sets of potential entities. Profiles for each of the plurality of entities 102 may be regenerated to generate new set of clusters. Further, the new set of potential entities may be identified using the new set of clusters. In an embodiment, the prediction of the plurality of potential entities 214 may be performed at beginning of every month. In an embodiment, the prediction of the plurality of potential entities 214 may be performed at regular intervals of time.

The other data 216 may store data, including temporary data and temporary files, generated by modules for performing the various functions of the system 101. The one or more modules 108 may also include other modules 207 to perform various miscellaneous functionalities of the system 101. It will be appreciated that such modules may be represented as a single module or a combination of different modules.

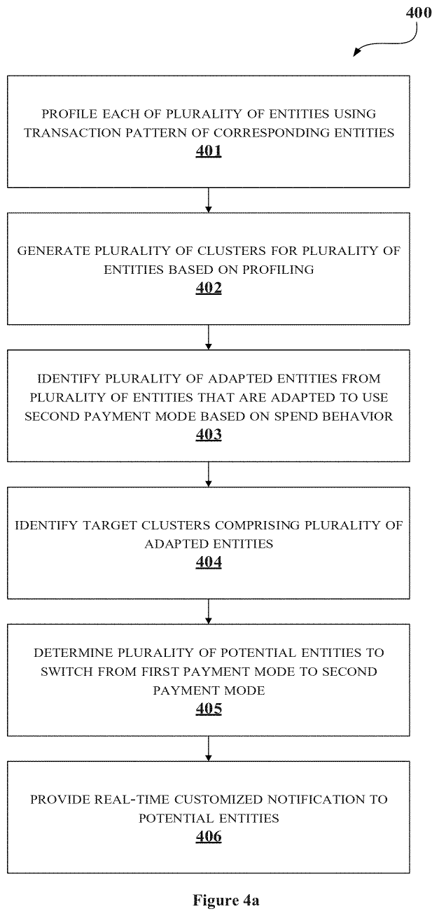

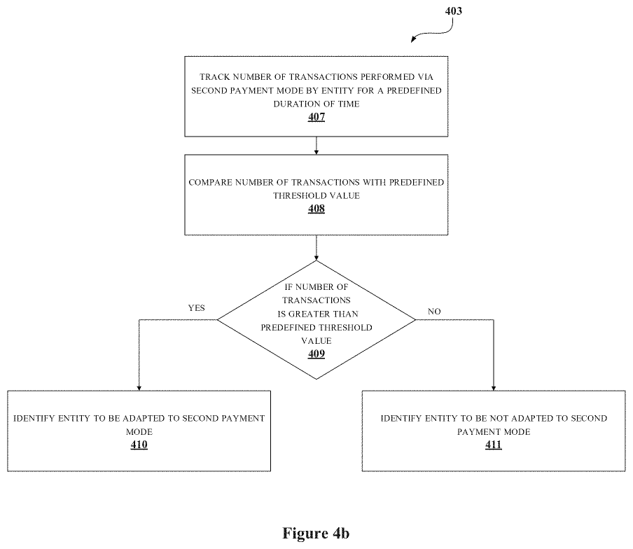

FIG. 4a illustrates a flowchart showing an exemplary method to predict the potential entities to switch from the first payment mode to the second payment mode, in accordance with some embodiments of present disclosure. FIG. 4a is intended to disclose algorithms or functional descriptions that may be used as a basis of writing computer programs to implement the functions that are described herein, and which cause a computer to operate in the new manner that is disclosed herein. Further, FIG. 4a is provided to communicate such an algorithm at the same level of detail that is normally used, by persons of skill in the art to which this disclosure is directed, to communicate among themselves about plans, designs, specifications and algorithms for other computer programs of a similar level of complexity. The steps of FIG. 4a may be performed in any order and are not limited to the order shown.

At block 401, the profile generator module 201 may be configured to profile each of the plurality of entities using transaction pattern 209 of the corresponding entities. One or more techniques, known to a person skilled in the art, may be implemented for profiling each of the plurality of entities. In an embodiment, the transaction pattern 209 may include the transaction data and the merchant data. In an embodiment, the transaction pattern 209 of an entity may include every detail relating to a transaction of the entity.

At block 402, the cluster generator module 202 may be configured to generate the plurality of clusters 210 for the plurality of entities 102. Each of the plurality of clusters 210 may include one or more entities with similar transaction patterns. In an embodiment, the inter-cluster distance and the intra-cluster similarities may be computed for increasing the effectiveness of generation of the clusters. Grouping of entities to form the plurality of clusters 210 may be performed using one or more features associated with transactions of the plurality of entities. In an embodiment, k-means clustering technique may be implemented to generate the plurality of clusters 210.

At block 403, the adapted entity identify module 203 may be configured to identify the plurality of adapted entities 212 which are adapted to use the second payment mode. The plurality of adapted entities 212 may be identified based on the spend behavior 211 of the corresponding entity. FIG. 4b illustrates a flowchart showing an exemplary method to identify the plurality of adapted entities 212, in accordance with some embodiments of present disclosure. FIG. 4b is intended to disclose algorithms or functional descriptions that may be used as a basis of writing computer programs to implement the functions that are described herein, and which cause a computer to operate in the new manner that is disclosed herein. Further, FIG. 4b is provided to communicate such an algorithm at the same level of detail that is normally used, by persons of skill in the art to which this disclosure is directed, to communicate among themselves about plans, designs, specifications and algorithms for other computer programs of a similar level of complexity. The steps of FIG. 4b may be performed in any order and are not limited to the order shown.

At block 407, the adapted entity identify module 203 may be configured to track number of transactions performed via the second payment mode. The tracking may be performed for a predefined duration of time. In an embodiment, the transaction pattern 209 of the entity may be used to track the number of transactions. In an embodiment, the number of transactions may be referred to as the spend behavior 211 of an entity. For example, consider transaction of an entity is tracked for a duration of one year. Total number of transactions performed by the entity is 80. The adapted entity identify module 203 may track number of transactions performed by the entity using the second payment mode to be 46.

At block 408, the adapted entity identify module 203 may be configured to compare the number of transactions with a predefined threshold value. In an embodiment, the predefined threshold value may be equal to half of total number of transactions performed by the entity. From previous example, the total number of transactions is 80. The adapted entity identify module 203 may compare the number of transactions using the second payment mode which is 46 with the total number of transactions of the entity.

At block 409, the adapted entity identify module 203 may be configured to check if the number of transactions is greater than the predefined threshold value. If the number of transactions is greater than the predefined threshold value, step in block 410 is performed by the adapted entity identify module 203. If the number of transactions is lesser than the predefined threshold value, step in block 411 is performed by the adapted entity identify module 203. In the given example since the number of transactions using the second payment mode is 46 which is greater than the total number of transactions, step in block 410 is performed, for the entity. Consider the number of transactions using the second payment mode of the entity is 35. In this case, since the number of transactions using the second payment mode is 35 which is lesser than the total number of transactions, step in block 411 is performed, for the entity.

At block 410, when the number of transactions is greater than the predefined threshold value, the adapted entity identify module 203 may be configured to identify the entity to be adapted to the second payment mode. From the given example, since the number of transactions using the second payment mode is 46 which is greater than the total number of transactions, the entity is identified to be adapted to the second payment mode.

At block 411, when the number of transactions is lesser than the predefined threshold value, the adapted entity identify module 203 may be configured to identify the entity to be not adapted to the second payment mode. When the number of transactions using the second payment mode is 35 which is lesser than the total number of transactions, the entity is identified to be not adapted to the second payment mode.

In an embodiment, the steps illustrated in FIG. 4b may be performed for each of the plurality of entities 102 to determine each entity to be an adapted entity and thereby, identify the plurality of adapted entities 212 from the plurality of entities 102.

Referring back to FIG. 4a, at block 404, upon identifying the plurality of adapted entities 212, the target cluster identify module 204 may be configured to identify the target clusters 213 from the plurality of clusters 210. Clusters with the plurality of adapted entities 212 may be considered to be target clusters 213. In an embodiment, if more than 50% of the entities in a clusters are adapted entities, then the cluster may be identified to be the target cluster.

At block 405, the potential entity identify module 205 may be configured to identify the plurality of potential entities 214 to switch from the first payment mode to the second payment mode. Entities apart from the adapted entities 212 in the target clusters 213 may be predicted to be the potential entities 214. Such potential entities may be considered to be target entities to promote switching from the first payment mode to the second payment mode.

At block 406, the notification provide module 206 may be configured to provide real-time customized notification 215 to the plurality of potential entities 214. In an embodiment, the real-time customized notification 215 may be provided to the user device of respective potential entity. In an embodiment, the notification 215 may be advertisement, offers, discounts, coupons and so on.

As illustrated in FIGS. 4a and 4b, the methods 400 and 403 may include one or more blocks for executing processes in the system 101. The methods 400 and 403 may be described in the general context of computer executable instructions. Generally, computer executable instructions can include routines, programs, objects, components, data structures, procedures, modules, and functions, which perform particular functions or implement particular abstract data types.

The order in which the methods 400 and 403 are described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

An embodiment of the present disclosure provisions accurate prediction of potential entities to switch from first payment mode to second payment mode. Also, the present disclose provision to provide customized notification to the potential entities. Hence, high success rate of switch from first payment mode to second payment mode may be achieved.

An embodiment of the present disclosure eliminates sending notification to entities who may not be potentially switching from first payment mode to second payment mode. Thereby, computation time for promoting units may be reduced. Also, channel traffic may be effectively used.

### Computing System

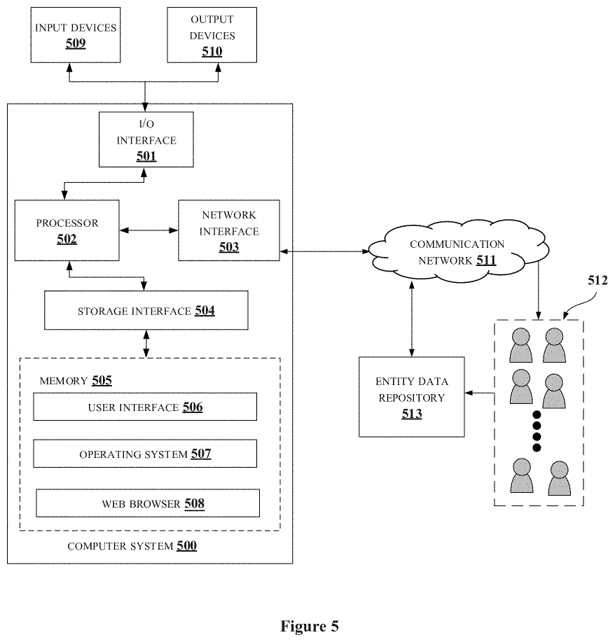

FIG. 5 illustrates a block diagram of an exemplary computer system 500 for implementing embodiments consistent with the present disclosure. In an embodiment, the computer system 500 is used to implement the system 101. The computer system 500 may include a central processing unit (“CPU” or “processor”) 502. The processor 502 may include at least one data processor for executing processes in Virtual Storage Area Network. The processor 502 may include specialized processing units such as, integrated system (bus) controllers, memory management control units, floating point units, graphics processing units, digital signal processing units, etc.

The processor 502 may be disposed in communication with one or more input/output (I/O) devices 509 and 510 via I/O interface 501. The I/O interface 501 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices 509 and 510. For example, the input devices 509 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 510 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 may consist of the system 101. The processor 502 may be disposed in communication with the communication network 511 via a network interface 503. The network interface 503 may communicate with the communication network 511. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 511 may include, without limitation, a direct interconnection, local area network (LAN), wide area network (WAN), wireless network (e.g., using Wireless Application Protocol), the Internet, etc. Using the network interface 503 and the communication network 511, the computer system 500 may communicate with plurality of entities 512 and an entity data repository 513 for predicting potential entities to switch from first payment mode to second payment mode. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 511 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web browser 508, etc. In some embodiments, computer system 500 may store user/application data 506, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, Adobe Flash, JavaScript, Java, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, which may be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 4a and 4b show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method comprising:
profiling each entity of a plurality of entities using a transaction pattern of corresponding entities, wherein the plurality of entities use a first payment mode;
generating a plurality of clusters for the plurality of entities based on the profiling, wherein each cluster of the plurality of clusters comprises one or more entities with a similar transaction pattern;
identifying a plurality of adapted entities from the plurality of entities that are adapted to use a second payment mode, based on tracking a spend behavior of each entity of the plurality of entities;
identifying one or more clusters from the plurality of clusters, comprising the plurality of adapted entities, to be target clusters;
determining a plurality of predicted entities in the target clusters as one or more potential entities to switch from the first payment mode to the second payment mode, wherein the predicted entities do not include any entities from the plurality of adapted entities; and
providing real-time customized notification to the predicted entities, to promote to switch from the first payment mode to the second payment mode,
wherein the method is performed using one or more processors.

2. The computer-implemented method as claimed in claim 1, wherein the first payment mode is payment via card transaction and the second payment mode is payment via user device.

3. The computer-implemented method as claimed in claim 1, wherein the transaction pattern of an entity comprises merchant data and transaction data associated with transactions of the entity.

4. The computer-implemented method as claimed in claim 1, wherein the plurality of clusters are generated using K-means clustering technique.

5. The computer-implemented method as claimed in claim 1, wherein generating the plurality of clusters comprises computing inter-cluster distances and intra-cluster similarities for the plurality of clusters, based on the transaction pattern associated with the one or more entities in corresponding clusters.

6. The computer-implemented method as claimed in claim 1, wherein identifying the plurality of adapted entities from the plurality of entities, comprises:
tracking a number of transactions performed by the entity via the second payment mode, for a predefined duration of time; and
identifying the entity to be adapted to the second payment mode when the number of transactions is greater than a predefined threshold value.

7. The computer-implemented method as claimed in claim 6, wherein the predefined threshold value is half of total number of transactions performed by the entity.

8. A system, comprising:
a processor; and
a memory communicatively coupled to the processor, wherein the memory stores processor-executable instructions, which, on execution, cause the processor to:
profile each entity of a plurality of entities using a transaction pattern of corresponding entities, wherein the plurality of entities use a first payment mode;
generate a plurality of clusters for the plurality of entities based on the profiling, wherein each cluster of the plurality of clusters comprises one or more entities with a similar transaction pattern;
identify a plurality of adapted entities from the plurality of entities that are adapted to use a second payment mode, based on tracking a spend behavior of each entity of the plurality of entities;
identify one or more clusters from the plurality of clusters, comprising the plurality of adapted entities, to be target clusters;
determine a plurality of predicted entities in the target clusters as one or more potential entities to switch from the first payment mode to the second payment mode, wherein the predicted entities do not include any entities from the plurality of adapted entities; and
provide real-time customized notification to the predicted entities, to promote to switch from the first payment mode to the second payment mode, wherein the method is performed using one or more processors.

9. The system as claimed in claim 8, wherein the first payment mode is payment via card transaction and the second payment mode is payment via user device.

10. The system as claimed in claim 8, wherein the transaction pattern of an entity comprises merchant data and transaction data associated with transactions of the entity.

11. The system as claimed in claim 8, wherein the plurality of clusters are generated using K-means clustering technique.

12. The system as claimed in claim 8, wherein generating the plurality of clusters comprises computing inter-cluster distances and intra-cluster similarities for the plurality of clusters, based on the transaction pattern associated with the one or more entities in corresponding clusters.

13. The system as claimed in claim 8, wherein the processor identifies the plurality of adapted entities from the plurality of entities by:
tracking a number of transactions performed by the entity via the second payment mode, for a predefined duration of time; and
identifying the entity to be adapted to the second payment mode when the number of transactions is greater than a predefined threshold value.

14. The system as claimed in claim 13, wherein the predefined threshold value is half of total number of transactions performed by the entity.

15. A non-transitory computer readable medium including instructions stored thereon that when processed by at least one processor cause a device to perform operations comprising:
profiling each entity of a plurality of entities using a transaction pattern of corresponding entities, wherein the plurality of entities use a first payment mode;
generating a plurality of clusters for the plurality of entities based on the profiling, wherein each cluster of the plurality of clusters comprises one or more entities with a similar transaction pattern;
identifying a plurality of adapted entities from the plurality of entities that are adapted to use a second payment mode, based on tracking a spend behavior of each entity of the plurality of entities;
identifying one or more clusters from the plurality of clusters, comprising the plurality of adapted entities, to be target clusters;
determining a plurality of predicted entities in the target clusters as one or more potential entities to switch from the first payment mode to the second payment mode, wherein the predicted entities do not include any entities from the plurality of adapted entities; and
providing real-time customized notification to the predicted entities, to promote to switch from the first payment mode to the second payment mode,
wherein the method is performed using one or more processors.

16. The medium as claimed in claim 15, wherein the first payment mode is payment via card transaction and the second payment mode is payment via user device.

17. The medium as claimed in claim 15, wherein the transaction pattern of an entity comprises merchant data and transaction data associated with transactions of the entity.

18. The medium as claimed in claim 15, wherein the plurality of clusters are generated using K-means clustering technique.

19. The medium as claimed in claim 15, wherein generating the plurality of clusters comprises computing inter-cluster distances and intra-cluster similarities for the plurality of clusters, based on the transaction pattern associated with the one or more entities in corresponding clusters.

20. The medium as claimed in claim 15, wherein identifying the plurality of adapted entities from the plurality of entities, comprises:
tracking a number of transactions performed by the entity via the second payment mode, for a predefined duration of time; and
identifying the entity to be adapted to the second payment mode when the number of transactions is greater than a predefined threshold value, wherein the predefined threshold value is half of total number of transactions performed by the entity.
